(19) United States
(12) Patent Application Publication
(10) Pub. No.: US 2015/0159664 A1
(43) Pub. Date: Jun. 11, 2015

(54) COMPRESSOR COVER FOR TURBOCHARGERS

(71) Applicant: BorgWarner Inc., Auburn Hills, MI (US)

(72) Inventors: Daniel M. Olin, Hendersonville, NC (US); Douglas Erber, Asheville, NC (US)

(21) Appl. No.: 14/405,205

(22) PCT Filed: Jun. 10, 2013
(86) PCT No.: PCT/US2013/044918

§ 371 Date: Dec. 3, 2014

Related U.S. Application Data
(60) Provisional application No. 61/661,126, filed on Jun. 18, 2012.

(51) Int. Cl. F04D 27/00; F02B 47/08; F04D 17/10

(52) U.S. Cl. CPC F04D 27/009; F04D 17/10; F02B 47/08

(57) ABSTRACT

A compressor housing (16) for a turbocharger with a recirculation cavity (60) formed between a volute base portion (40), an inducer (44) and an inlet section (46) to bleed airflow from a compressor impeller (14) back into 46 the inlet section (46). Bleed airflow can enter an angled recirculation slot (70) adjacent to the compressor impeller (14) and then flow through a recirculation cavity (60) formed in the compressor housing (16) to an inlet re-entry slot (72) in the inlet section (46). Such recirculated airflow can improve surge margin. The inducer (44) includes a ring (50) with an inner surface (56) that preferably aligns with a converging wall (54) of the inlet section (46), which may be a separate piece attachable to a base of the compressor housing (16). Normal airflow from the compressor impeller (14) continues through the volute base portion (40) to an engine intake manifold.

### CROSS-REFERENCE TO RELATED APPLICATION

This application claims priority to and all the benefits of U.S. Provisional Application No. 61/661,126, filed on Jun. 18, 2013, and entitled “Compressor Cover for Turbochargers,” which is incorporated herein by reference.

### BACKGROUND

1. Field of the Disclosure

This disclosure relates to a component for turbochargers for internal combustion engines with an emphasis on passenger car usage. More particularly, this disclosure relates to a compressor cover with recirculation geometry for airflow.

2. Description of Related Art

Advantages of turbocharging include increased power output, lower fuel consumption and reduced pollutant emissions. The turbocharging of engines is no longer primarily seen from a high power performance perspective, but is rather viewed as a means of reducing fuel consumption and environmental pollution on account of lower carbon dioxide (CO₂) emissions. Currently, a primary reason for turbocharging is using the exhaust gas energy to reduce fuel consumption and emissions. In turbocharged engines, combustion air is pre-compressed before being supplied to the engine. The engine aspirates the same volume of air-fuel mixture as a naturally aspirated engine, but due to the higher pressure, thus higher density, more air and fuel mass is supplied into a combustion chamber. Consequently, more fuel can be burned, so that the engine's power output increases relative to the speed and swept volume.

In exhaust gas turbocharging, some of the exhaust gas energy, which would normally be wasted, is used to drive a turbine. The turbocharger returns some of this normally wasted exhaust energy back into the engine, contributing to the engine's efficiency and saving fuel. A compressor, which is mounted on the same shaft as the turbine, draws in filtered ambient air, compresses it, and then supplies it to the engine.

A turbocharger is a type of forced induction system used with internal combustion engines. Turbochargers deliver compressed air to an engine intake, allowing more fuel to be combusted, thus boosting an engine's horsepower without significantly increasing engine weight. Thus, turbochargers permit the use of smaller engines that develop the same amount of horsepower as larger, naturally aspirated engines. Using a smaller engine in a vehicle has the desired effect of decreasing the mass of the vehicle and enhancing fuel economy. Moreover, the use of turbochargers permits more complete combustion of the fuel delivered to the engine, which contributes to the highly desirable goal of a cleaner environment.

Turbochargers typically include a turbine housing connected to the engine's exhaust manifold, a compressor housing connected to the engine's intake manifold, and a center bearing housing coupling the turbine and compressor housings together. A turbine wheel in the turbine housing is rotatably driven by an inflow of exhaust gas supplied from the exhaust manifold. A shaft rotatably supported in the center bearing housing connects the turbine wheel to a compressor impeller in the compressor housing so that rotation of the turbine wheel causes rotation of the compressor impeller. The shaft connecting the turbine wheel and the compressor impeller defines an axis of rotation.

This disclosure focuses on a compressor of a turbocharger. The compressor is designed to help increase the intake manifold pressure and density to allow the engine cylinders to ingest a greater mass of air during each intake stroke. The performance of the compressor is shown on a chart commonly called a “map.”

The compressor performance map defines, based on inlet conditions, the usable operating characteristics of the compressor in terms of airflow and pressure ratio. The compressor RPM lines show, for a stated compressor speed, the pressure ratio delivered as a function of airflow.

A line extending up the left side of the map is referred to as a surge line. It defines, for each pressure ratio, the minimum airflow at which the compressor can operate with sufficient air system stability. The surge line indicates when there is a full system reversal of flow. Local stall conditions can occur to the right of the surge line and may propagate to other locations in the compressor.

A compressor with a “ported shroud” has been successful in widening the map. It improves surge margin. It moves the surge line to the left by allowing a small amount of airflow to bleed off a tip of the compressor impeller and recirculate, to ward off blade stall and for surge control. Recirculated airflow allows for surge control, and normal airflow continues through the compressor housing/volute to the intake manifold. This feature is illustrated schematically in FIG. 1 as “Prior Art.”

It is desirable therefore to provide a compressor with an improved surge margin and a wider compressor performance map so that at a given pressure ratio and/or a given compressor impeller linear tip speed, a larger spread of airflow values are available between a surge line and a choke line of the compressor map. Also, with turbochargers for passenger car engines being expected to operate at wider ranges and regions on the map, noise, vibration and harshness (NVH) characteristics must also be considered.

### SUMMARY

The disclosure provides for a compressor for an automotive turbocharger that improves surge margin, i.e., a surge line on a compressor performance map is moved to the left, by allowing airflow to bleed off a tip of a compressor impeller and recirculate into an inlet section of a compressor housing. The geometry and improved aerodynamics of the recirculation features provide added benefits with airflow, surge margin and noise characteristics.

A compressor housing includes a converging nozzle inlet combined with a recirculation cavity, angled recirculation slot and an inlet re-entry slot. The recirculation cavity may be formed between a volute base portion, an inducer and an inlet section to bleed airflow from a compressor impeller back into the inlet section. Airflow can enter an angled recirculation slot adjacent to the compressor impeller and then flow through the recirculation cavity formed in the compressor housing to the inlet re-entry slot in the inlet section. The inducer preferably includes a ring portion with inner surface walls that align with converging walls of the inlet section for smooth airflow. The volute base portion, the contour, the inducer and the inlet section can be separately machined or molded parts, which may allow for ease of production, testing, assembly or tailoring parts for specific applications.

Also, with improved geometry for recirculated airflow with improved surge control, the noise is reduced with better performance toward surge when passenger cars operate in the extreme regions of the compressor performance map. Such maps confirm noise reduction wherein a negative slope of the speed line shows quieter operation (flat or positive slope may indicate a noisier condition).

The angled recirculation slot reduces noise though various operating ranges. Certain choppy airflow is stabilized and smoothed out. Also, noise at hearable levels is minimized by removing a portion of support struts at a lower part of the recirculation cavity, thus allowing uninterrupted flow around that annulus. Accordingly, such recirculation geometry of the compressor housing improves surge margin and NVH characteristics of the compressor of the turbocharger.

### BRIEF DESCRIPTION OF THE DRAWINGS

Advantages of the present disclosure will be readily appreciated as the same becomes better understood by reference to the following detailed description when considered in connection with the accompanying drawings wherein:

FIG. 1 is a cross-sectional view of a compressor housing with a ported shroud showing recirculated airflow according to the prior art;

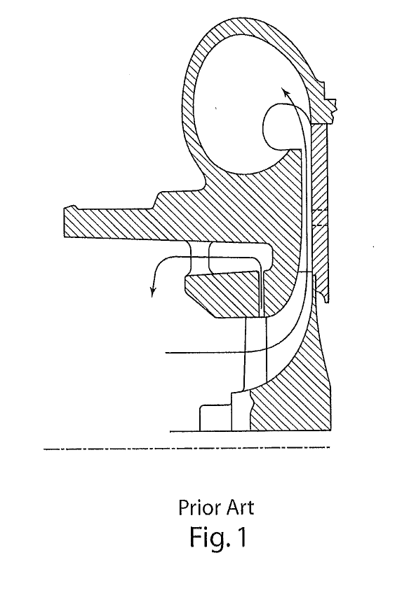

FIG. 2 is a cross-sectional of a perspective view of a compressor end of a turbocharger according to one embodiment;

FIG. 3 is a cross-sectional view of the compressor end of the turbocharger according to another embodiment; and

FIG. 4 is a compressor performance map comparing a standard compressor design without recirculation in dashed lines to a compressor design with recirculation geometry in solid lines.

### DETAILED DESCRIPTION OF THE EMBODIMENTS

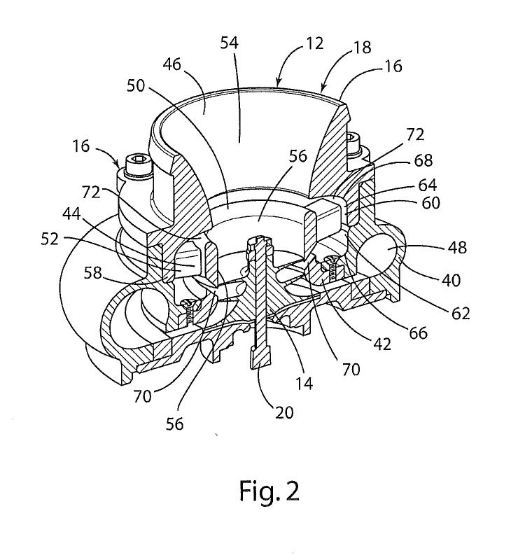

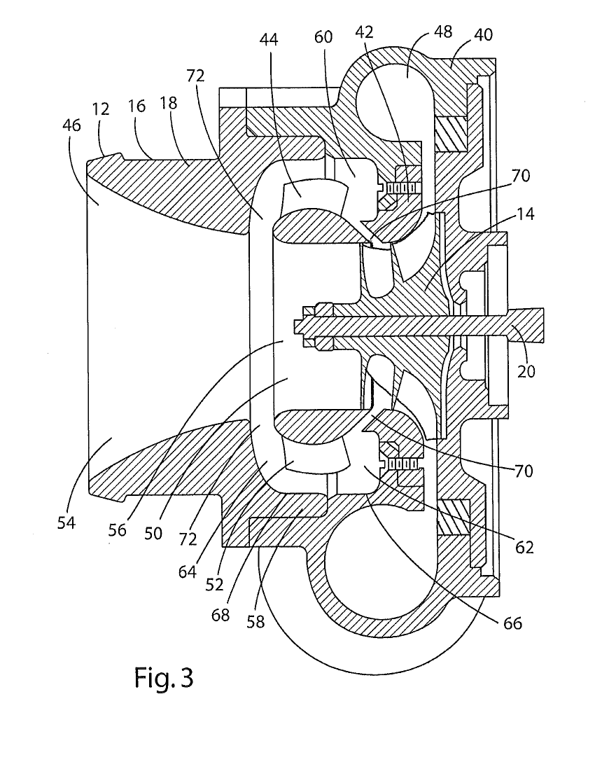

Referring to FIGS. 2 and 3, a turbocharger is generally understood. A compressor end 12 of a turbocharger can include a compressor impeller 14, and a compressor housing 16, including a compressor cover 18. A rotating shaft 20 is driven by a turbine wheel such that rotation of the turbine wheel causes rotation of the compressor impeller 14.

The compressor impeller 14 is mounted on one end of the shaft 20 and is housed within the compressor housing 16. As is known in the art, the turbine wheel is rotatably driven by an inflow of exhaust gas supplied from an exhaust manifold, which rotates the shaft 20, thereby causing the compressor impeller 14 to rotate. As the compressor impeller 14 rotates, air is drawn in and is compressed to be delivered at an elevated pressure to an intake manifold of an engine. In other words, the compressor impeller 14 is rotatably driven by the turbine wheel. After driving the turbine wheel, the exhaust gas can be discharged or in some cases recirculated.

The compressor housing 16 is meant to broadly mean the component that houses the compressor impeller 14 and includes the compressor cover 18. This includes a volute base portion 40, a contour 42, an inducer 44 and an inlet section 46. As shown in FIGS. 2 and 3, the components can be separately machined or molded parts, which may allow for ease of production, testing, assembly or tailoring parts for specific turbocharger applications. Also, it is contemplated that any or all of these parts can be formed as integral or combined components.

The volute base portion 40 is fairly standard with an air passage 48 that gets larger as it approaches discharge for more static pressure. As detailed below, the volute base portion 40 may be molded or machined to cooperate with the inducer 44 and the inlet section 46 to form cavities for recirculation of airflow. The volute base portion 40 is operably connected and adjacent to the compressor impeller 14 to also provide normal airflow to the engine.

The contour 42 may be cut into the compressor housing 16 or a piece fastened to the volute base portion 40 so that it complementarily matches the compressor impeller 14. The contour 42 surrounds and encircles a portion of blades on the compressor impeller 14 in close tolerances to avoid contact with the compressor impeller 14 as it rotates. If the inducer 44 and the inlet section 46 are switched out to meet different parameters, the contour 42 would likely stay secured to the volute base portion 40 with its complementary compressor impeller 14.

The inducer 44 may form a ring 50 around a distal end of the compressor impeller 14, and a series of extending members 52 may radially extend from the ring 50. The extending members 52 can be perpendicular to the ring 50 or they may be angled (on either axis) relative to the ring 50 or shaft 20 to direct recirculation airflow into the inlet section 46 with rotation or counter-rotation relative to the movement of the compressor impeller 14.

The inlet section 46 is the outermost portion of the cover 18 where air flows in. As shown in FIGS. 2 and 3, the inlet section 46 has a tapered conical wall 54 forming a converging nozzle inlet. The tapered conical wall 54 of the inlet section 46 is preferably aligned with an inner surface wall 56 of the ring 50 of the inducer 44 for smooth air flow. The top of the inner surface wall 56 is preferably rounded. A portion 58 of the cover 18 may extend from and be secured to the volute base portion 40.

A recirculation cavity 60 may be formed around and adjacent to the ring 50 of the inducer 44. The recirculation cavity 60 may be formed by hollows 62 and 64 formed by a volute middle wall 66 and an inlet section hollow wall 68. As shown in FIGS. 2 and 3, the extending members 52 of the inducer 44 can extend to engage the inlet section hollow wall 68 of the inlet section 46. The extending members 52 may engage and be secured by (or integrally formed with) either or both the volute middle wall 66 and the inlet section hollow wall 68.

The recirculation cavity 60 may include an angled recirculation slot 70 and an inlet re-entry slot 72. The angled recirculation slot 70 surrounds the leading edge of the compressor impeller 14. Its angle may be formed by the bottom of the ring 50 of the inducer 44 and a portion of the contour 42. The inlet re-entry slot 72 is preferably open between the tapered conical wall 54 and the inner surface wall 56 of the ring 50 for airflow to be recirculated. Widths of the angled recirculation slot 70 and the inlet re-entry slot 72 can vary to achieve desired airflow.

The angled recirculation slot 70 provides an escape path for air on the slower tip of the compressor impeller 14. The air is recirculated through the recirculation cavity 60 and out the inlet re-entry slot 72 back into the inlet section 46 for surge control. In the process, the surge margin is improved and extended when operating on the left side of the map. On the right side of the map, the operating range can also be extended.

The specific geometry of the recirculation components also adds stability to the airflow. The choppy air noise can be smoothed out and stabilized. The recirculation to the inlet section 46 can stabilize the entire compressor stage of turbocharger, particularly when the compressor impeller 14 is operated near its surge point.

As shown in cross section of the inducer 44 of FIG. 2, the ring 50 is rather straight with somewhat parallel sides. As shown in FIG. 3, the cross section of the ring 50 may be more tear-drop shaped. A more gradual angle and elliptical shape may promote better recirculation airflow with less heat.

The inlet section 46 can be formed as a component attachable to the volute base portion 40 with a complementary lip as shown in FIGS. 2 and 3. The inducer 44 may also be a separately formed piece that can sit inside the volute base portion 40 and be enclosed by the inlet section 46 wherein the extending members 52 engage and secure the inducer 44 within the cover 18.

When these parts are made for turbochargers for passenger cars, the component widths are narrower than larger applications so that individually forming components to strict tolerances may be desired. The thickness may be a few millimeters. The geometry of the recirculation components can be tuned for a compressor compatible with a passenger car internal combustion engine and the regions on the map where passenger car applications may need to operate. Also, as features become more complex or may vary (such as gap width), this can be accomplished by separate components making up the cover 18.

The recirculated airflow in the compressor cover 18 is continuous during operation of the turbocharger. It is different from, but can be integrated with, the exhaust gas recirculation that passes through an Exhaust Gas Recirculation valve (EGR valve or sometimes CRV compressor recirculation valve) and is usually cooled in that exhaust gas recirculation process. In that operation, the exhaust gas is mixed with fresh air toward the compressor and as combined enters the engine's intake manifold. Separate cover components can also facilitate incorporating EGR features and elements.

It is contemplated that the exhaust gas recirculation could enter into the recirculation cavity 60 so both recirculated airflows could be combined in the cover 18, wherein the CRV might operate only during a throttle closing event to help prevent compressor backflow and related compressor surging. Exhaust gas may help direct airflow in the inlet section 46.

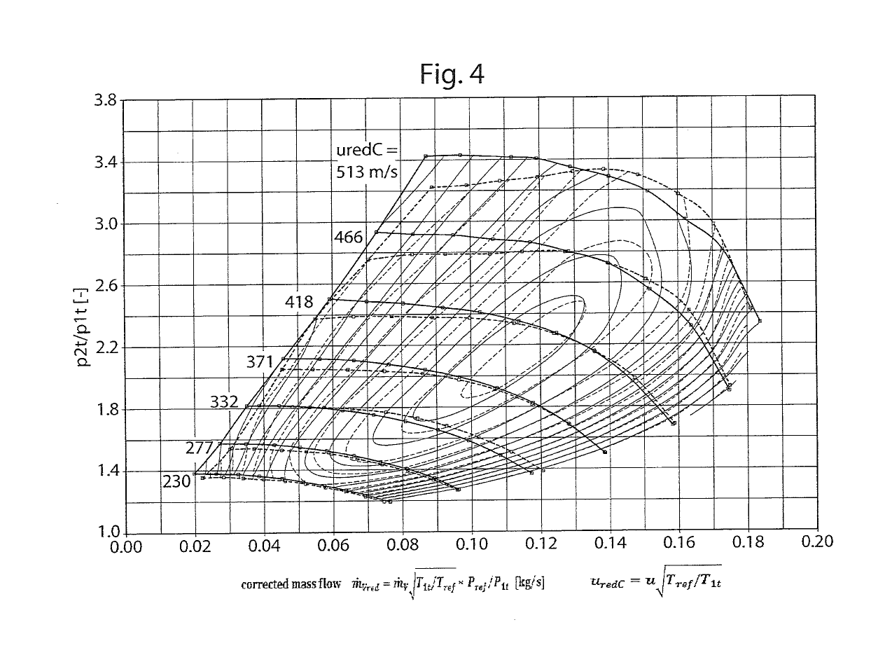

FIG. 4 shows a compressor performance map for one embodiment of this disclosure with surge line extended to the left to widen the map by allowing a small amount of airflow to bleed off the tip of the compressor impeller 14 and recirculate with non-turbulent airflow. For comparison, the compressor performance map includes a standard compressor design without recirculation in dashed lines and the present compressor design with recirculation geometry in solid lines.

The invention has been described in an illustrative manner, and it is to be understood that the terminology used is intended to be in the nature of words of description rather than limitation. Many modifications and variations of the present invention are possible in light of the above teachings. It is, therefore, to be understood that within the scope of the appended claims, the invention may be practiced other than as specifically enumerated within the description.

What is claimed:

1. A turbocharger having a compressor impeller (14) and a turbine wheel connected by a rotating shaft (20), the improvement comprising a compressor housing (16) with recirculation geometry including:
a volute base portion (40) operably adjacent to the compressor impeller (14);
a contour (42) that encircles and complementarily matches the compressor impeller (14);
an inducer (44) including a ring (50) and extending members (52);
an inlet section (46) extending from the volute base portion (40); and
a recirculation cavity (60) formed in the volute base portion (40) and the inlet section (46) with a recirculation slot (70) and an inlet slot (72) for reentry of airflow into the inlet section (46);
wherein a converging wall (54) of the inlet section (46) aligns with an inner surface (56) of the ring (50) of the inducer (44).

2. The turbocharger of claim 1 wherein surge margin is improved by allowing airflow to bleed off a tip of the compressor impeller (14) and recirculate into the inlet section (46).

3. The turbocharger of claim 1 wherein the geometry of the recirculation components are tuned for compatibility with a passenger car internal combustion engine.

4. The turbocharger of claim 1 wherein the inlet section (46) is formed as a component attachable to the volute base portion (40).

5. The turbocharger of claim 1 wherein the ring (50) of the inducer (44) forms the recirculation slot (70) at an angle from the inner surface (56) of the ring (50).

6. The turbocharger of claim 5 wherein the cross section of the ring (50) forms a tear-drop shape.

7. The turbocharger of claim 1 wherein the extending members (52) extend radially to engage a wall (66 and/or 68) of the recirculation cavity (60) of the inlet section (46).

8. The turbocharger of claim 1 wherein the extending members (52) of the inducer (44) are angled relative to the ring (50) to direct recirculation airflow into the inlet section (46) with rotation relative to the movement of the compressor impeller (14).

9. The turbocharger of claim 1 wherein the ring (50) of the inducer (44) forms the recirculation slot (70) and the extending members (52) are angled relative to the ring (50).

10. The turbocharger of claim 9 wherein the inducer (44) is a separate piece that can sit inside the volute base portion (40) and be enclosed by the inlet section (46) wherein the extending members (52) engage and secure the inducer (44) within the compressor housing (16).

11. A turbocharger for a passenger car internal combustion engine including a compressor impeller (14) and a turbine wheel connected by a rotating shaft (20), the compressor impeller (14) operably connected and adjacent to a compressor housing (16) with recirculation geometry, the compressor housing (16) comprising:
a volute base portion (40) operably connected and adjacent to the compressor impeller (14);
an inducer (44) including a ring (50) with extending members (52), wherein the ring (50) of the inducer (44) forms a side of an angled recirculation slot (70);
an inlet section (46) formed as a component attached to the volute base portion (40); wherein the inducer (44) is between the volute base portion (40) and the inlet section (46); and
a recirculation cavity (60) formed in the volute base portion (40) and the inlet section (46) with the angled recirculation slot (70) and an inlet slot (72) for reentry of recirculated airflow into the inlet section (46);
wherein compressor surge margin is improved by allowing airflow to bleed off the compressor impeller (14) through the angled recirculation slot (70) and the recirculation cavity (60) via the inlet slot (72) into the inlet section (46).
